(19) United States
(12) Patent Application Publication
(10) Pub. No.: US 2003/0174964 A1
(43) Pub. Date: Sep. 18, 2003

(54) Lens coupling fiber attachment for polymer optical waveguide on polymer substrate

(75) Inventors: Renyuan Gao, Strafford, PA (US); Kazuya Takayama, Phoenixville, PA (US); Anthony Garito, Radnor, PA (US)

Correspondence Address: MONTE & MCGRAW, PC, 4092 SKIPPACK PIKE, P.O. BOX 650, SKIPPACK, PA, 19474, US

(73) Assignee: Photon-X, Inc., Malvern, PA

(21) Appl. No.: 10/337,202

(22) Filed: Jan. 6, 2003

Related U.S. Application Data
(60) Provisional application No. 60/346,735, filed on Jan. 8, 2002.

(51) Int. Cl. G02B 6/30; G02B 6/26

(52) U.S. Cl. 385/49; 385/50; 385/31

(57) ABSTRACT

An optical waveguide assembly is disclosed. The assembly includes a substrate lying in a plane. The substrate includes a covered surface and an exposed surface. The substrate further includes a channel formed therein along an axis generally perpendicular to the plane from the exposed surface toward the covered surface. A first cladding layer is disposed on the covered surface of the substrate. A core is disposed on the first cladding layer, wherein the core intersects the axis. An optical fiber is disposed within the channel so that a signal light is transmittable between the core and the optical fiber.

### FIELD OF THE INVENTION

The present invention relates to integrated optical waveguide devices, particularly polymer optical waveguide devices, and structures and methods for connecting optical fibers to the devices.

### BACKGROUND OF THE INVENTION

Planar optical waveguides may be formed in polymers by using a core polymer and a cladding polymer disposed over a substrate, with the core polymer refractive index being slightly higher than that of the cladding polymer in the near infrared region of the optical telecommunications wavelength window. Various optical devices, such as integrated splitters, couplers, arrayed waveguide gratings, and optical waveguide amplifiers can be formed with planar optical waveguides. In order to insert optical waveguide devices into optical fiber communication networks, it is essential to have the capability to connect optical fibers to the waveguides. It is desirable to have a low loss, low cost and reliable fiber attachment method for waveguides.

The previously known technology for connecting an optical fiber to a waveguide used adhesive bonding, such as epoxy, combined with precision alignment of the fiber to the waveguide before and during the bonding process. With long exposure to signal light and environmental changes, the adhesive in the optical path between the fiber and the waveguide can suffer from aging and, as a result, suffer from optical absorption and scattering induced performance degradation.

One known method requires aligning a fiber array with an optical waveguide along a six-degrees-of-freedom precision alignment station, in which both the fiber array and the waveguide must be matched both linearly and rotationally along x, y, and z axes. Such fiber-to-waveguide alignment requires sub-micron precision, which is extremely difficult and time-consuming. Because of these reasons, fiber-to-waveguide attachment is the bottleneck for planar optical waveguide device fabrication.

It would be desirable to provide a planar optical waveguide structure that allowed for fast, easy, inexpensive, and reliable attachment of an optical fiber to the waveguide, without the need for adhesive bonding.

### BRIEF SUMMARY OF THE INVENTION

Briefly, the present invention provides an optical waveguide assembly. The assembly includes a substrate lying in a plane. The substrate includes a covered surface and an exposed surface. The substrate further includes a channel formed therein along an axis generally perpendicular to the plane from the exposed surface toward the covered surface. A first cladding layer is disposed on the covered surface of the substrate. A core is disposed on the first cladding layer, wherein the core intersects the axis.

Additionally, the present invention provides an optical fiber and waveguide assembly comprising. The planar optical waveguide includes a substrate laying in a plane. The substrate includes a covered surface and an exposed surface. The substrate further includes a channel formed therein along an axis generally perpendicular to the plane from the exposed surface toward the covered surface. A first cladding layer is disposed on the covered surface of the substrate. A core is disposed on the first cladding layer, wherein the core intersects the axis. An optical fiber having a free end is disposed within the channel, such that the optical fiber and the core are optically connected to each other.

Further, the present invention provides a method of transmitting light between an optical fiber and a planar optical waveguide. The method comprises transmitting a signal light along an optical fiber to a free end of the fiber; transmitting the signal light from the free end of the optical fiber generally perpendicularly to a plane of and through a generally planar substrate; transmitting the signal light from the substrate through a cladding layer; transmitting the signal light from the cladding layer through a core layer to a reflective surface; and reflecting the signal light from the reflective surface along the core, generally parallel to the plane of the substrate.

The present invention also provides a method of transmitting a signal light between a planar optical waveguide and an optical fiber. The method comprises reflecting the signal light off a reflector disposed at an angle relative to the planar optical waveguide such that the signal light is redirected between a first direction in a plane of the planar optical waveguide and a second direction perpendicular to the plane of the planar optical waveguide.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view, partially in section, of a planar optical waveguide assembly according to a first embodiment of the present invention.

FIG. 2 is a side view, in section of the planar optical waveguide assembly of FIG. 1, connected to an optical fiber, showing signal light transmission between the optical waveguide assembly and the optical fiber.

FIG. 3 is a perspective view of a planar optical waveguide assembly according to a second embodiment of the present invention.

FIG. 4 is a perspective view of an arrayed waveguide grating utilizing the planar optical waveguide assemblies of the first and second embodiments.

### DETAILED DESCRIPTION OF THE INVENTION

In the drawings, like numerals indicate like elements throughout. Two elements are said to be “optically connected” to each other when a light signal is able to be transmitted between the two elements.

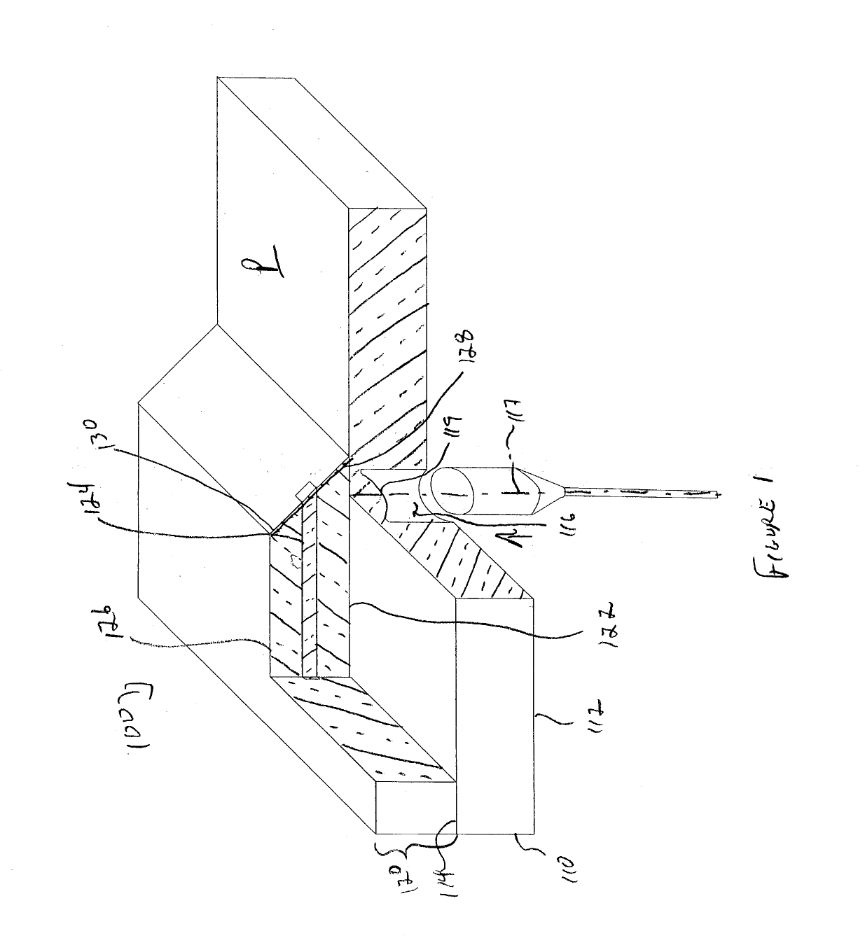

Referring to FIG. 1, a partial sectional view of an optical waveguide assembly 100 according to an embodiment of the present invention is shown. The assembly 100 is constructed from a planar substrate 110 that extends along a plane P. Preferably, the substrate 110 is constructed from a polymer, and more preferably, from a polymer constructed from at least one of polycarbonate, polymethylmethacrylate, cellulosic, thermoplastic elastomer, ethylene butyl acrylate, ethylene vinyl alcohol, ethylene tetrafluoroethylene, fluorinated ethylene propylene, polyperfluoroalkoxyethylene, nylon, polybenzimidazole, polyester, polyethylene, polyamide, polystyrene, polysulfone, polyvinyl chloride, polyvinylidene fluoride, polyacrylonitrile butadiene styrene, acetal copolymer, poly[2,2-bistrifluoromethyl-4,5-difluoro-1,3-dioxole-co-tetrafluoroethylene], which is sold under the trademark TEFLON® AF and poly[2,2,4-trifluoro-5-trifluoromethoxy-1,3-dioxole-co-tetrafluoroethylene] which is sold under the trademark HYFLON® AD60, poly[2,3-(perfluoroalkenyl) perfluorotetrahydrofuran] which is sold under the trademark CYTOP®, diallyl phthalate, epoxy, furan, phenolic, thermoset polyester, polyurethane, and vinyl ester, or combinations and blends of more than one of these materials, although those skilled in the art will recognize that other suitable materials may be used. The polymer used to fabricate the substrate 110 must be transparent and must have reasonably low scattering and absorption loss in the near infrared region. Preferably, the absorption and scattering loss at 1550 nanometers is less than 1 dB per millimeter, to ensure low loss fiber attachment with the waveguide 100.

The substrate 110 includes an exposed surface 112 and a covered surface 114. The substrate 110 also includes a channel 116 that extends from the exposed surface 112 toward, but not to, the covered surface 114. The channel 116 extends along a channel axis 117 that is preferably generally perpendicular to the plane P. The channel 116 has a closed end 118 that incorporates a collimating lens 119. The collimating lens 119 is preferably convex in shape to collimate light passing through the collimating lens 119.

Preferably, the substrate 110 is manufactured by an injection molding process, which is known in the art, with the channel 116, the closed end 118, and the collimating lens 119 being formed in the substrate 110 during the molding process. However, those skilled in the art will recognize that the channel 116, the closed end 118, and the collimating lens 119 may be formed after manufacture of the substrate 110, such as by laser ablation or other known methods. Preferably, the channel 116 has a width of approximately 100-2000 microns, to allow insertion of a single mode optical fiber with a collimating lens into the channel 116.

An optical waveguide 120 is disposed on the covered surface 114. The optical waveguide 120 includes a lower cladding 122 disposed directly on the covered surface 114 of the substrate 110, a core 124 disposed over at least a portion of the lower cladding 122, and an upper cladding 126 disposed over the core 124 and a remaining portion of the lower cladding 122. Preferably, the lower cladding 122 and the upper cladding 126 are constructed from a first polymer and the core 124 is constructed from a second polymer, such that the refractive index of the second polymer, in the near infrared optical telecommunication wavelength window of approximately 1550 nanometers, is slightly higher than that of the first polymer in the same wavelength window, to promote total internal reflection of a signal light being transmitted through the core 124, as is well known in the art. Also preferably, the first polymer and the second polymer are from a polymer constructed from at least one of an optical polymer, including but not limited to TEFLON® AF, HYFLON® AD60, CYTOP® or combinations and blends of more than one of these materials, although those skilled in the art will recognize that other suitable materials may be used. Further, the core 124 may include rare earth ions and/or other metals to enable the waveguide assembly 100 to amplify light, as is well known in the art. It is desired that the substrate 110 and the waveguide 120 have coefficients of thermal expansion that differ by less than approximately 30 percent, to minimize phase shift of signal light as a result of temperature fluctuations of the assembly 100.

Preferably, the waveguide 120 is formed by depositing the lower cladding 122, the core 124, and the upper cladding 126 over the substrate 110 by methods known in the art, such as, for example, by spincoating, and by reactive ion etching the core 124 to form the core 124 in a desired shape. Using a mask aligner, the core 124 is aligned with the channel 116 so that the core 124 is generally centered over the collimating lens 119 and intersects the channel axis 117.

After the waveguide 120 is formed, a 45 degree sloped surface 128, cutting across each of the lower cladding 122, the core 124, and the upper cladding 126, is formed in the waveguide 120 relative to the plane P. Preferably, the sloped surface 128 us formed using known techniques such as diamond saw dicing, laser ablation, or micro-toming. A reflective material 130 is then disposed over the sloped surface 128. The reflective material 130 may be a metal or other reflective material.

The sloped surface 128 is located relative to the channel 116 and the channel axis 117 such that signal light being transmitted along the core 124 toward the reflective material reflects off the reflective material 130 and is redirected 90 degrees into the channel 116, generally along the channel axis 117.

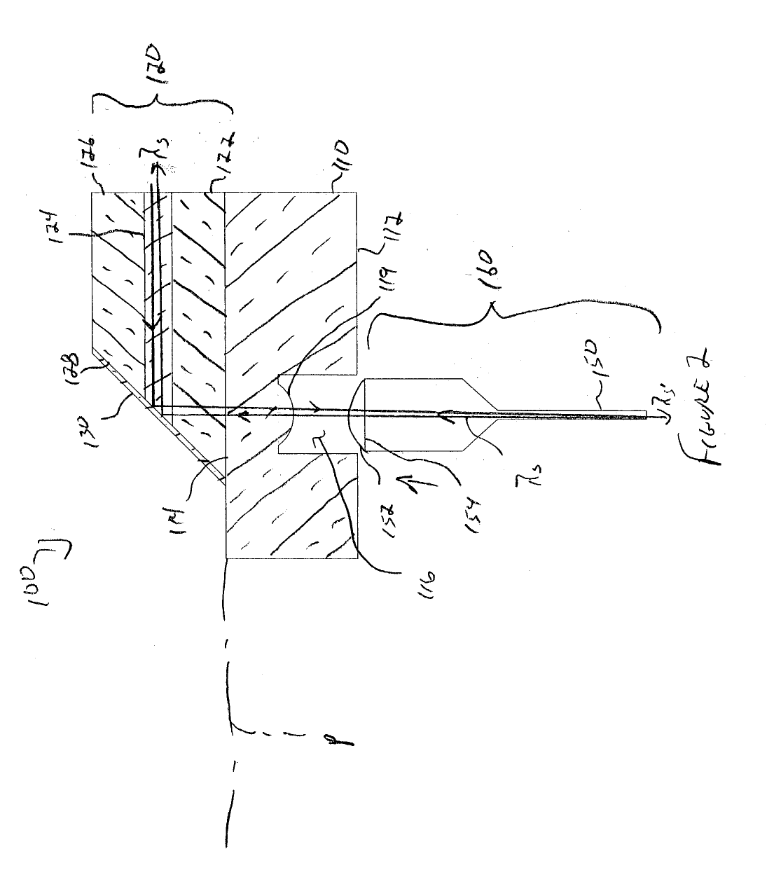

The embodiment of the assembly 100 shown in FIG. 2 is constructed for a single optical fiber 150 to be inserted into the channel 116 such that the optical fiber 150 is optically connected to the core 124. The optical fiber 150 includes a collimating lens 152 disposed on a free end 154 thereof to form a fiber attachment subassembly 160. Preferably, the collimating lens 152 is formed using a graded index optical lens or a fiber lens, as is known by those skilled in the art. The fiber attachment subassembly 160 is sized to be able to insert the collimating lens 152 and the free end 154 of the optical fiber 150 into the channel 116.

The collimating lens 119 and the collimating lens 152 serve as beam expanders that expand a single mode signal light beam, being transmitted through the waveguide assembly 100 and the optical fiber 150, having mode field diameters of between approximately 5 and 15 microns to between approximately 100 and 2000 microns. Such expansion decreases the precision alignment requirement to align the optical fiber 150 to the core 124 from between approximately 0.2 to 1 microns to approximately between 20 and 200 microns, a requirement that is easily satisfied by the precision of the molded channel 116 and collimating lens 119 according to the present invention.

Referring still to FIG. 2, in operation, the optical fiber 150 is inserted into the channel 116 and a signal light λₛ is transmitted along the optical fiber 150 to the collimating lens 152. The collimating lens 152 collimates the signal light λₛ. The signal light λₛ is then transmitted to the collimating lens 119, where the signal light is further collimated. The signal light λₛ next passes, generally perpendicular to the plane P, through the substrate 110 and the lower cladding 122 and enters the core 124. The signal light λₛ reflects off the reflective material 130 and travels along the core 124 from left to right in FIG. 2, generally parallel to the plane P. Similarly, a signal light λ_{s′} may be transmitted along the core 124, generally parallel to the plane P, from right to left as shown in FIG. 2. The signal light λ_{s′} reflects off the reflective material 130 and is directed generally perpendicular to the plane P, through the lower cladding 122 and the substrate 10 to the collimating lens 119, where the signal light is collimated. The signal light λ_{s′} next passes through the collimating lens 152 to the optical fiber 150, where the signal light λ_{s′} travels along the optical fiber 150.

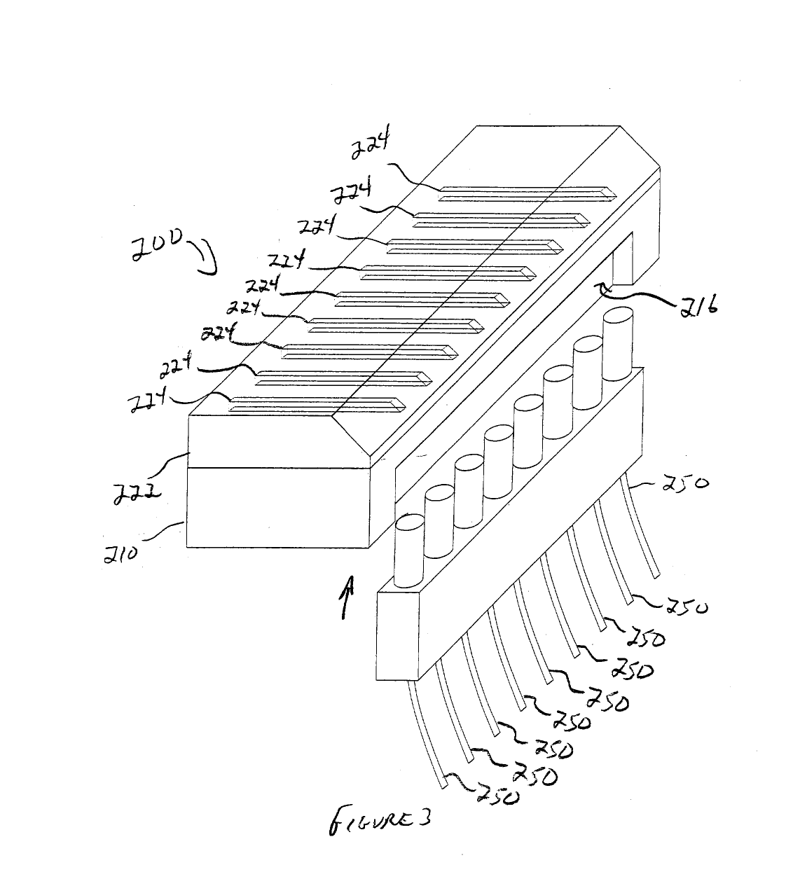

In an alternate embodiment of the present invention, shown as an optical waveguide assembly 200 in FIG. 3, the assembly 200 incorporates a plurality of cores 224 disposed within a cladding 222, and incorporating a substrate 210 with a channel 216 sufficiently large to accept a like plurality of optical fibers 250 inserted into the channel 216. While eight cores 224 and eight corresponding optical fibers 250 are shown, those skilled in the art will recognize that more or less than eight cores 224 and eight optical fibers 250 may be used. Collimating lenses have been omitted from FIG. 3 for clarity, although those skilled in the art will recognize that collimating lenses may be formed in the substrate 210 and on the fibers 150 in the same manner as described with respect to the first embodiment described above.

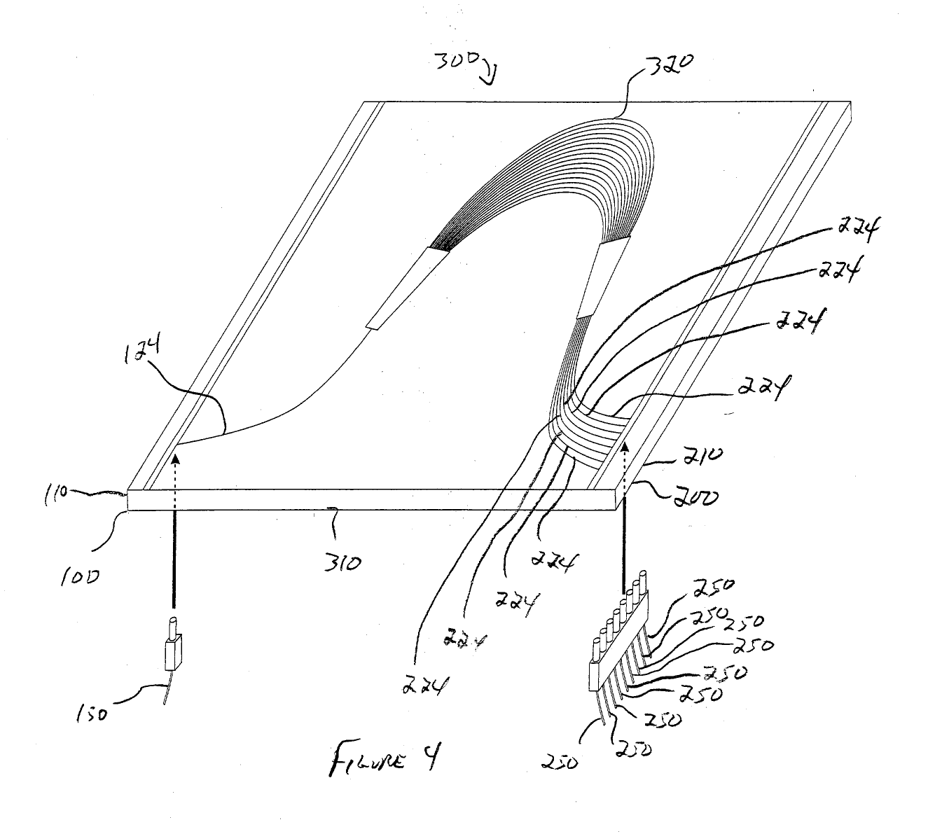

Referring now to FIG. 4, an arrayed waveguide grating (AWG) 300, utilizing the optical waveguide assemblies 100, 200, is shown. The AWG 300 includes a substrate 310 which is comprised of the substrate 110 and the substrate 210. The core 124 splits along an array 320, forming the plurality of cores 224. The optical fiber 150 is optically connected to the core 124 and the optical fibers 250 are each connected to one of the cores 224, such that the optical fiber 150 is optically connected to the optical fibers 250. Collimating lenses have been omitted from FIG. 3 for clarity, although those skilled in the art will recognize that collimating lenses may be formed in the substrate 310 and on the fibers 150, 250 in the same manner as described with respect to the first embodiment described above.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An optical waveguide assembly comprising:
a substrate laying in a plane, wherein the substrate includes a covered surface and an exposed surface, wherein the substrate includes a channel formed therein along an axis generally perpendicular to the plane from the exposed surface toward the covered surface;
a first cladding layer disposed on the covered surface of the substrate; and
a core disposed on the first cladding layer, wherein the core intersects the axis.

2. The optical waveguide assembly according to claim 1, wherein the channel further comprises a closed end proximate to the closed surface, and wherein the closed surface includes a convex surface.

3. The optical waveguide assembly according to claim 1, wherein the core includes an end surface disposed approximately 45 degrees relative to the axis.

4. The optical waveguide assembly according to claim 3, wherein the end surface is coated with a reflective material.

5. The optical waveguide assembly according to claim 1, wherein the substrate is constructed from a transparent polymer.

6. The optical waveguide assembly according to claim 5, wherein the polymer has an absorption and scattering loss of less than 1 dB per millimeter for light having a wavelength of approximately 1550 nanometers.

7. The optical waveguide assembly according to claim 5, wherein the polymer is at least one from the group consisting of polycarbonate, polymethylmethacrylate, cellulosic, thermoplastic elastomer, ethylene butyl acrylate, ethylene vinyl alcohol, ethylene tetrafluoroethylene, fluorinated ethylene propylene, polyperfluoroalkoxyethylene, nylon, polybenzimidazole, polyester, polyethylene, polyamide, polystyrene, polysulfone, polyvinyl chloride, polyvinylidene fluoride, polyacrylonitrile butadiene styrene, acetal copolymer, poly[2,2-bistrifluoromethyl-4,5-difluoro-1,3-dioxole-co-tetrafluoroethylene], poly[2,2,4-trifluoro-5-trifluoromethoxy-1,3-dioxole-co-tetrafluoroethylene], poly[2,3-(perfluoroalkenyl) perfluorotetrahydrofuran], diallyl phthalate, epoxy, furan, phenolic, thermoset polyester, polyurethane, and vinyl ester.

8. The optical waveguide assembly according to claim 1, further comprising a second cladding layer disposed over the core.

9. The optical waveguide assembly according to claim 1, wherein the waveguide assembly comprises an arrayed waveguide grating.

10. The optical fiber and waveguide assembly according to claim 1, wherein the substrate and the waveguide have coefficients of thermal expansion that differ by less than approximately 30 percent.

11. An optical fiber and waveguide assembly comprising:
a planar optical waveguide including:
a substrate laying in a plane, wherein the substrate includes a covered surface and an exposed surface, wherein the substrate includes a channel formed therein along an axis generally perpendicular to the plane from the exposed surface toward the covered surface;
a first cladding layer disposed on the covered surface of the substrate; and
a core disposed on the first cladding layer, wherein the core intersects the axis
and
an optical fiber having a free end disposed within the channel, such that the optical fiber and the core are optically connected to each other.

12. The optical fiber and waveguide assembly according to claim 11, wherein the channel further comprises a closed end proximate to the closed surface, and wherein the closed surface includes a convex surface.

13. The optical fiber and waveguide assembly according to claim 11, wherein the core includes an end surface disposed approximately 45 degrees relative to the axis.

14. The optical fiber and waveguide assembly according to claim 13, wherein the end surface is coated with a reflective material.

15. The optical fiber and waveguide assembly according to claim 11, wherein the substrate is constructed from a transparent polymer.

16. The optical fiber and waveguide assembly according to claim 15, wherein the polymer has an absorption and scattering loss of less than 1 dB per millimeter for light having a wavelength of approximately 1550 nanometers.

17. The optical fiber and waveguide assembly according to claim 15, wherein the polymer is at least one from the group consisting of polycarbonate, polymethylmethacrylate, cellulosic, thermoplastic elastomer, ethylene butyl acrylate, ethylene vinyl alcohol, ethylene tetrafluoroethylene, fluorinated ethylene propylene, polyperfluoroalkoxyethylene, nylon, polybenzimidazole, polyester, polyethylene, polyamide, polystyrene, polysulfone, polyvinyl chloride, polyvinylidene fluoride, polyacrylonitrile butadiene styrene, acetal copolymer, poly[2,2-bistrifluoromethyl-4,5-difluoro-1,3-dioxole-co-tetrafluoroethylene], poly[2,2,4-trifluoro-5-trifluoromethoxy-1,3-dioxole-co-tetrafluoroethylene], poly[2,3-(perfluoroalkenyl) perfluorotetrahydrofuran], diallyl phthalate, epoxy, furan, phenolic, thermoset polyester, polyurethane, and vinyl ester.

18. The optical fiber and waveguide assembly according to claim 11, further comprising a second cladding layer disposed over the core.

19. The optical fiber and waveguide assembly according to claim 11, wherein the waveguide assembly comprises an arrayed waveguide grating.

20. The optical fiber and waveguide assembly according to claim 11, wherein the optical fiber comprises a plurality of optical fibers and the core comprises a like plurality of cores, wherein each of the plurality of optical fibers is optically connected to one of the like plurality of cores.

21. The optical fiber and waveguide assembly according to claim 11, wherein the substrate and the waveguide have coefficients of thermal expansion that differ by less than approximately 30 percent.

22. A method of transmitting light between an optical fiber and a planar optical waveguide comprising:
transmitting a signal light along an optical fiber to a free end of the fiber;
transmitting the signal light from the free end of the optical fiber generally perpendicularly to a plane of and through a generally planar substrate;
transmitting the signal light from the substrate through a cladding layer;
transmitting the signal light from the cladding layer through a core layer to a reflective surface; and
reflecting the signal light from the reflective surface along the core, generally parallel to the plane of the substrate.

23. The method according to claim 22, wherein, as the signal light is transmitted from the free end of the optical fiber, the signal light is collimated.

24. The method according to claim 22, wherein, as the signal light is transmitted through the substrate, the signal light is collimated.

25. A method of transmitting a signal light between a planar optical waveguide and an optical fiber comprising reflecting the signal light off a reflector disposed at an angle relative to the planar optical waveguide such that the signal light is redirected between a first direction in a plane of the planar optical waveguide and a second direction perpendicular to the plane of the planar optical waveguide.

26. The method of claim 25, further comprising collimating the signal light between the reflector and the optical fiber.
